(19) United States
(12) Patent Application Publication
(10) Pub. No.: US 2019/0264494 A1
(43) Pub. Date: Aug. 29, 2019

(54) GLASS HEATING MECHANISMS AND METHODS OF MAKING INSULATING GLASS UNITS USING THE SAME

(71) Applicant: Apogee Enterprises, Inc., Minneapolis, MN (US)

(72) Inventors: Eric Stein, Owatonna, MN (US); Matthew Bergers, Lakeville, MN (US)

(21) Appl. No.: 16/281,581

(22) Filed: Feb. 21, 2019

Related U.S. Application Data
(60) Provisional application No. 62/634,570, filed on Feb. 23, 2018.

(51) Int. Cl. E06B 3/673; E06B 3/663

(52) U.S. Cl. CPC E06B 3/6733; C03C 23/007; E06B 3/66352

(57) ABSTRACT

A system for producing an insulating glass unit having at least two lites separated by a spacer material is disclosed. The system includes a heating mechanism to heat one or both of the lites to achieve rapid wet-out of the spacer material on the lites. A method of producing an insulating glass unit including heating one or both lites is further disclosed.

### CROSS REFERENCE TO RELATED APPLICATION

This application claims the benefit under 35 § 119 to U.S. Provisional Application No. 62/634,570, filed Feb. 23, 2018 and entitled “GLASS HEATING MECHANISMS AND METHODS OF MAKING INSULATING GLASS UNITS USING THE SAME,” the entirety of which is hereby incorporated by reference for all purposes.

### BACKGROUND

Insulating glass units (IGUs), such as double- or triple-pane windows, are constructed by extruding a thermoplastic spacer on an ambient-temperature lite of glass and then pressing together a second ambient-temperature lite of glass and the spacer. The hot spacer completely bonds (wets out) immediately to the first lite but complete wet-out on the second lite takes a minimum of several hours and can take up to three or more days. Spacer extruder parameters and press parameters can be adjusted to decrease wet-out times, but lag times generally remain for the onset of wet-out and complete wet-out remains slow.

Prior to complete wet-out, insulating glass units are typically stored upright and are neither packed nor shipped until completely wetted out.

Accordingly, there is a need in the industry for a mechanism and method for achieving faster or immediate wet-out of all lites used in the assembly of an insulating glass unit.

### SUMMARY

Embodiments of the invention relate to mechanisms, systems, and methods for heating one or more lites of an insulating glass unit to achieve rapid wet-out of the thermoplastic spacer to the lites.

An example embodiment of a method for producing an insulating glass unit including heating a second lite is disclosed. A spacer material is applied to a first lite and the first lite and the second lite are pressed together. In some implementations, the first lite is also heated.

An example embodiment of a method for producing an insulating glass unit including heating a first lite to which a spacer material has been applied is disclosed. The first lite and a second lite are pressed together. In some implementations, the second lite is also heated.

An example embodiment of a system for producing an insulating glass unit including a heating mechanism configured to heat at least one of a first lite and a second lite is disclosed. The system includes a thermoplastic material applicator configured to apply a spacer material to the first lite. The system includes a press configured to press together the first lite and the second lite.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIGS. 1A-1C are schematics of cut-a y portions of insulating glass units according to embodiments.

FIG. 2 is a schematic of an insulating glass unit formation system according to an embodiment.

FIGS. 3A-3D are flow diagrams of methods of making an insulating glass unit according to embodiments.

### DETAILED DESCRIPTION

Embodiments disclosed herein are related to mechanisms, systems, and methods of preparing insulating glass units. More particularly, embodiments relate to heat sources for and heating of at least one lite of glass for an insulating glass unit. Rapid wet-out of a plurality of lites is achieved by the mechanisms and methods disclosed herein.

### Insulating Glass Units

An insulating glass unit can be generally understood as two or more pieces of glass separated by one or more spacers and having at least one hermetically sealed airspace between at least two pieces of glass. Insulating glass units may be used in the construction of windows for buildings and may improve a window's thermal performance compared to a single pane of glass. Insulating glass units may absorb stress on the unit caused by thermal expansion and pressure, provide a barrier to water and moisture infiltration, create a barrier that reduces condensation, and/or reduce noise transfer.

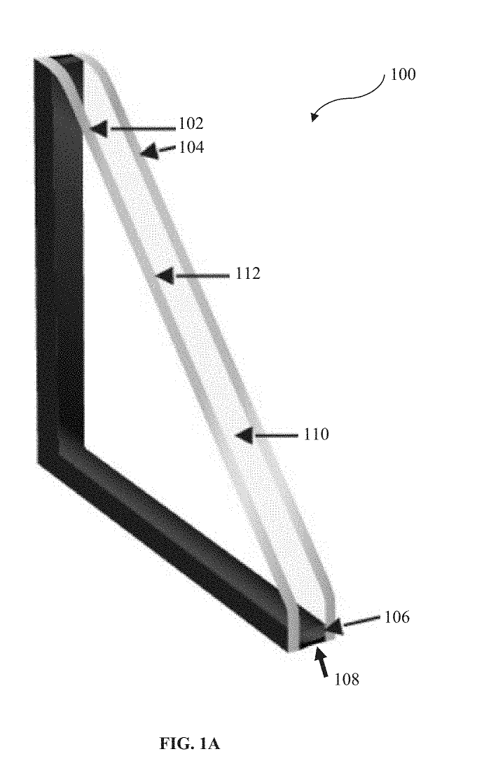

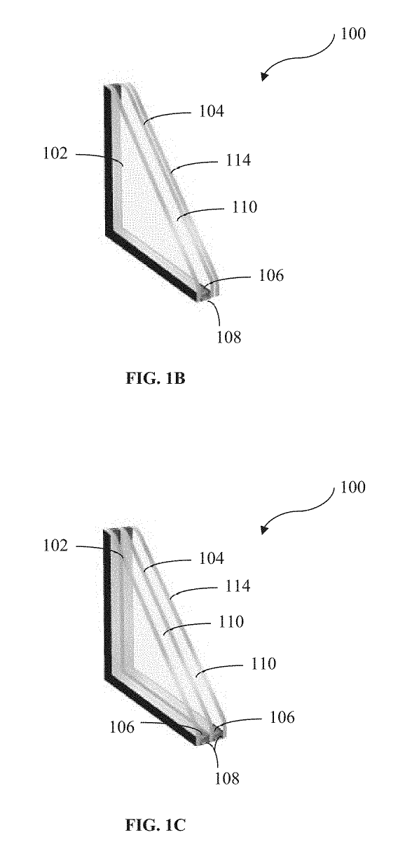

FIGS. 1A-1C are schematics of cut-away portions of insulating glass units 100 according to embodiments. The insulating glass unit 100 includes at least a first piece of glass (a first lite) 102 and a second lite 104. In some embodiments, and with reference to FIG. 1A, the insulating glass unit 100 is a double insulating glass unit. In some embodiments, and with reference to FIGS. 1B and 1C, the insulating glass unit 100 includes a third lite 114. The third lite 114 may form part of a laminated insulating glass unit 100 as illustrated in FIG. 1B. The third lite 114 may form part of a triple insulating glass unit 100 as illustrated in FIG. 1C. Additional lites may be included, such as a fourth lite, a fifth lite, and so on.

Any lite may be separated from an adjacent lite by a spacer 106 such that the insulating glass unit 100 includes one or more spacers 106. The spacer 106 may help to separate and maintain a separation between adjacent lites 102, 104, thereby forming a gap 110 between the lites 102, 104. The gap 110 may be filled with a gas, such as air, argon, or krypton. A coating 112, such as a low-emissivity (low-e) coating, may be applied to one or more surfaces of one or more lites 102, 104.

The insulating glass unit 100 may include a sealant 108. The sealant 108 may form a seal, such as a secondary seal, between two lites 102, 104. The sealant 108 may be positioned between the spacer 106 and the perimeter of the lites 102, 104. The sealant 108 may be positioned adjacent to, and may adhere to, one or both of the spacer 106 and the edges of the lites 102, 104. The sealant 108 may be constructed of a UV-resistant material. The sealant 108 may be constructed of silicone or a similar material, such as polysulfide or polyurethane. The silicone or similar material may harden or cure over time, such as in about 2 to about 24 hours.

In the implementation and use of an insulating glass unit 100, the sealant 108 may help hold the unit 100 together, may help provide a barrier to the ingress of air, moisture, or debris, and/or may help provide a barrier to the egress of gas from the gap 110.

The spacer 106 may be positioned between two adjacent lites 102, 104. The spacer 106 may form a seal, such as a primary seal, between adjacent lites 102, 104. The spacer 106 may be positioned at any location or plurality of locations between two adjacent lites 102, 104 and may have any shape or arrangement. For example, the spacer 106 may have a substantially linear shape and may traverse approximately the middle of the width of the lites 102, 104. As another example, the spacer 106 may be positioned inside the perimeter of the lites 102, 104, such as less than 25 cm interior to an outer edge of a lite 102, 104. The spacer 106 may run continuously, nearly continuously, or intermittently around and just interior to the perimeter of the lites 102, 104.

The spacer 106 may be a warm edge spacer, which may reduce thermal conduction compared to metal spacers. The spacer 106 may be constructed of a thermoplastic material. The spacer 106 may include an integrated desiccant. The spacer 106 may include a rubber material, such as a synthetic rubber material, which may be a gas-impermeable material. For example, the gas-synthetic rubber material may be polyisobutylene. One example of a thermoplastic spacer with an integrated desiccant and polyisobutylene is the Viracon Thermal Spacer (VTS™) (Viracon, Owatonna, Minn.).

The spacer 106 may have a thickness of about 5 mm to about 30 mm, about 5 mm to about 25 mm, about 5 mm to about 20 mm, about 5 mm to about 15 mm, about 5 mm to about 10 mm, about 10 mm to about 30 mm, about 15 mm to about 30 mm, about 20 mm to about 30 mm, about 25 mm to about 30 mm, or about 7 mm to about 20 mm.

In the implementation and use of an insulating glass unit 100, the spacer 106 may help hold the unit 100 together, may help absorb stress on the unit 100 caused by thermal expansion and pressure, may help provide a barrier to the egress of gas from the gap 110, and/or may help provide a barrier to water and moisture infiltration.

In the construction and assembly of an insulating glass unit 100, the spacer 106 may be installed as a spacer material. The spacer material may be applied directly to one or both of the first lite 102 and the second lite 104. The application may be by extrusion of a thermoplastic material onto a lite 102, 104. The spacer material and thereby the spacer 106 may adhere or bond (“wet out”) directly to one or more lites 102, 104. Without being limited to any mechanism or mode of action, the physical bonding may result from flowing of the spacer material into pores and microfeatures of a surface of a lite 102, 104.

In the construction and assembly of an insulating glass unit 100, the spacer material may be applied hot, such as about 110° C. to about 140° C., to a lite. The lite may be referred to as an applied lite or a first lite. The spacer material may achieve immediate or near-immediate complete or near-complete wet-out on the first lite. Another lite (match lite or second lite) is then pressed together with the side of the first lite to which the spacer material has been applied. In known methods of constructing and assembling an insulating glass unit, the spacer material does not achieve immediate or even rapid wet-out on the second lite. Wet-out on the second lite may not commence for at least about three hours. Complete wet-out on the second lite by the spacer material may takes a minimum of several hours and may take up to three or more days.

Without being limited to any mechanism of mode of action, the spacer material cools during the time (about 30 seconds to about 60 minutes) between extrusion onto the first lite and pressing with the second lite and the resulting lower surface temperature may not be conducive to fast or thorough wet-out of the spacer material on the second lite.

One or more of the lites may be heated to improve the speed and/or thoroughness of the wet-out of the second lite by the spacer material.

### Mechanisms for Heating Lites

A variety of mechanisms may be used to heat the lites 102, 104 described herein. Mechanisms include heating by radiation, convection, or conduction heat sources. Radiation-based heat sources may include infrared, shortwave, or medium wave radiation. Convection-based heat sources may include heated air or fluid. In one example, an air curtain helps convey a lite, such as on an insulating glass unit production line, and the lite is heated by thermal convection from a heated air curtain. Conduction-based heat sources may include a heated plate or board, such as a heated backboard or press board, contacting a lite.

The heat source may be sized and shaped to heat substantially an entire surface or surfaces of a lite. The heat source may be sized and shaped to heat a portion of a surface or surfaces of a lite, such as the portion that will contact the spacer material, which may be a portion proximate the perimeter of the lite.

The heat source may be oriented in the same direction as the lite, which may be substantially horizontal or substantially vertical. The heat source may be positioned in direct contact with or proximate to a surface of the lite. The heat source may be positioned, for example, less than about 12 inches, about 0.125 inch to about 10 inches, or about 3 inches to about 4 inches, from a surface of a lite.

In some embodiments, a heat source substantially surrounds a lite. For example, an oven surrounds a lite when the lite is placed inside the oven to be heated. In some embodiments, a heat source is positioned proximate to fewer than all surfaces of a lite. For example, a heat source may be positioned substantially parallel to one surface of a lite.

In some embodiments, a lite is heated by being placed in a heated room or being conveyed through a room that is heated or is not cooled. The lite may be conveyed on a rack or harp system, which may be heated.

The heat source may be capable of heating a lite to about 30° C. to about 180° C., about 30° C. to about 160° C., about 30° C. to about 140° C., about 30° C. to about 120° C., about 30° C. to about 100° C., about 30° C. to about 80° C., about 30° C. to about 60° C., about 50° C. to about 180° C., about 70° C. to about 180° C., about 90° C. to about 180° C., about 110° C. to about 180° C., about 130° C. to about 180° C., about 150° C. to about 180° C., about 30° C. to about 150° C., about 30° C. to about 130° C., about 50° C. to about 110 CC, or about 80° C. to about 90° C.

The heat source may be capable of quickly heating a lite. For example, a heat source may be able to heat a lite to about 100 CC in about 2 seconds.

One example of a heat source is one having about six short-wave twin-tube infrared emitters of about 10000 W, 480V each.

In some embodiments, a heat source is partially or fully integrated into a progressive assembly, such as an assembly line for producing insulating glass units. In some embodiments, a heat source is a free-standing or operationally independent device.

The heating mechanism may heat one or more lites, such as a first lite and/or a second lite. In some implementations, a spacer material has been applied to a lite before it is heated. In some implementations, a lite without application of a spacer material is heated. A heating mechanism may be included in a system for producing insulating glass units.

### Systems for Producing Insulating Glass Units

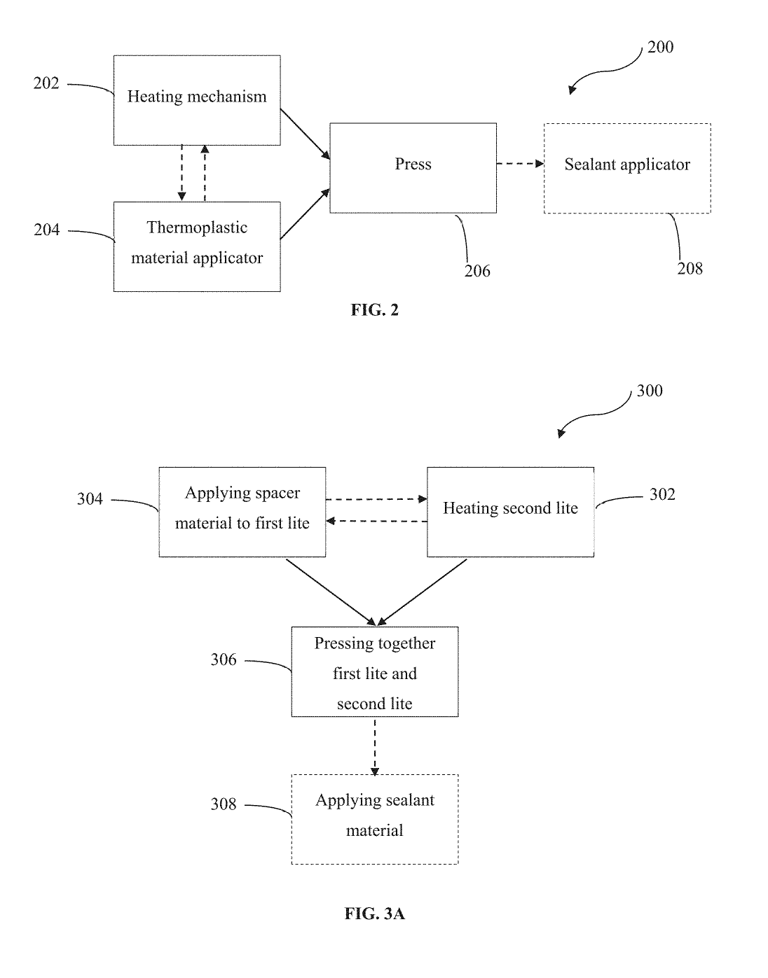

FIG. 2 illustrates a system 200 for producing an insulating glass unit and includes a heating mechanism 202, a thermoplastic material applicator 204, a press 206, and an optional sealant applicator.

The heating mechanism 202 is configured to heat at least one lite. The heating mechanism may be any mechanism described above.

The thermoplastic spacer applicator 204 is configured to apply a spacer material to at least one lite. The application may be by extrusion. The spacer material may be any spacer material described above, such as a thermoplastic material. The spacer material may be positioned as described above, such as along and interior to the perimeter of a lite.

The press 206 is configured to press together at least two lites, such as a first lite and a second lite. A spacer material may be positioned between at least a portion of the lites when the press 206 presses the lites together. The press 206 may be a platen press.

The sealant applicator 208 is configured to apply a sealant material to the pressed lites. The sealant material may be any sealant material described above, such as silicone. The sealant material may be positioned as described above, such as external to the spacer material, between the spacer material and the perimeter of the pressed lites.

The heating mechanism 202, thermoplastic material applicator 204, press 206, and optional sealant applicator 208 may operate sequentially in any order, contemporaneously, separately, together, or any combination thereof. For example, and as indicated by dashed arrows in FIG. 2, the heating mechanism 202 and the thermoplastic material applicator 204 may operate sequentially with either the heating mechanism 202 or the thermoplastic material applicator 204 operating first. As another example, the heating mechanism 202 and the thermoplastic material applicator 204 may operate contemporaneously, Each of the heating mechanism 202 and the thermoplastic material applicator 204 may operate before the press 206. In some embodiments, the heating mechanism 202 and the press 206 operate contemporaneously. In some embodiments, the heating mechanism 202 operates after the press 206 operates but before the sealant applicator 208, if a sealant applicator 208 is included in the system 200. In some embodiments, the heating mechanism 202 operates after the press 206 and after the sealant applicator 208, if a sealant applicator 208 is included in the system 200. In some embodiments, the system 200 includes a lite washing mechanism (not shown) and the heating mechanism 202 operates after the washing mechanism.

In the implementations and use of a system 200 for producing an insulating glass unit, including a heating mechanism 202 may help achieve a more extensive wet-out, such as complete wet-out, of the spacer material on a second lite faster than systems that do not include a heating mechanism 200. In systems that do not include a heating mechanism, complete second lite wet-out may take from several hours to several days.

Complete (0.100%) second lite wet-out, as determined by the method described in Example 1 below, may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 90% to about 100% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 80% to about 90% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 70% to about 80% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

In the implementations and use of a system 200 for producing an insulating glass unit, rapid and extensive wet-out of the second lite permits accurate inspection of insulating glass units soon or immediately after assembly. Real-time adjustment of operational parameters, such as of the heating mechanism 202, thermoplastic material applicator 204; and/or press 206 is possible if, for example, poor wet-out is observed. Compared to slow second lite wet-out of known systems for producing an insulating glass unit, the presently disclosed rapid and extensive wet-out of the second lite may help decrease or eliminate the need for insulating glass unit storage space prior to shipping, decrease or eliminate insulating glass unit storage time prior to shipping, decrease the time between assembly and laying an insulating glass unit in a horizontal position, decrease the time between assembly and packing of an insulating glass unit, and/or decrease the time between assembly and shipping of an insulating glass unit insulating.

### Methods of Preparing Insulating Glass Units

Methods of preparing or assembling an insulating glass unit are disclosed herein. The insulating glass unit may include at least a first lite and a second lite. The insulating glass unit may include one or more additional lites, such as a third lite or a fourth lite. The insulating glass unit may be a laminated glass unit or a triple (or quadruple, or so on) insulating glass unit or any combination thereof. During assembly of an insulating glass unit having more than two lites, two lites may be assembled as a double insulating glass unit or as a laminate and then a third lite may be assembled with the double insulating glass unit or with the laminate. The assembly of the third lite and the double insulating glass unit or the third lite and the laminate may be similar to the assembly of the first lite and the second lite. As used in the methods disclosed herein, the term “lite” may refer to a single piece of glass or an assembly of a plurality of pieces of glass. The assembly may be, for example, a laminate or an insulating glass unit, which may be a double insulating glass unit.

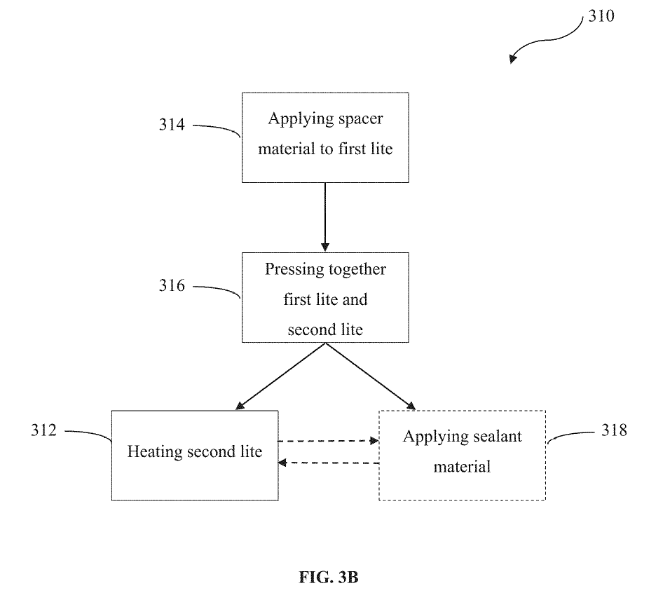

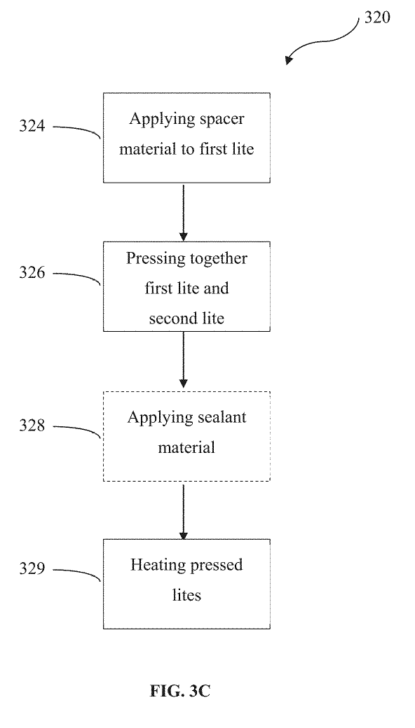

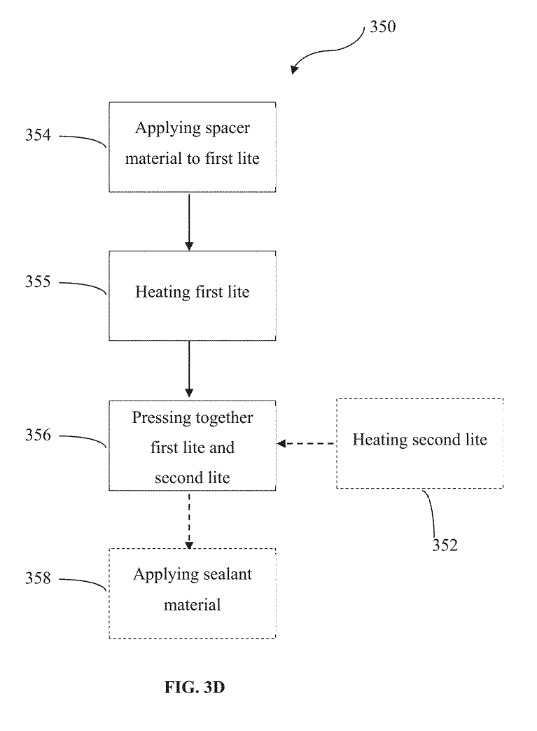

With reference to FIG. 3A, a method 300 of preparing an insulating glass unit includes a step 302 of heating a second lite; a step 304 of applying a spacer material to a first lite; and a step 306 of pressing together the first lite and the second lite. In some embodiments, the method 300 includes a step 308 of applying a sealant material.

The steps 302, 304, 306, and 308 (optionally) of the method 300 may be performed sequentially in any order, contemporaneously, separately, together, or any combination thereof. For example, and as indicated by dashed arrows in FIG. 3A, step 302 and step 304 may be performed sequentially with either step 302, 304 being performed first or the steps 302, 304 may be performed contemporaneously. Each of step 302 and 304 may be performed before step 306. In some embodiments, step 302 and step 306 occur contemporaneously. In some embodiments, step 302 occurs after step 306 but before step 308, if step 308 is included in the method 300. In some embodiments, step 302 occurs after step 306 and after step 308, if step 308 is included in the method 300. In some embodiments, the method 300 includes a step (not shown) of washing one or more lites and step 302 occurs after the washing step.

In some implementations, the method 300 is performed on an assembly line, such as a line for producing insulating glass units. In some implementations, one or more of steps 302, 304, 306, and 308 are performed discretely or not as part of a progressive assembly.

In step 302, the second lite is heated by any mechanism described above, such as an infrared heat source. The second lite may be heated to a temperature of about 30° C. to about 180° C., about 30° C. to about 160° C., about 30° C. to about 140° C., about 30° C. to about 120° C., about 30° C. to about 100° C., about 30° C. to about 80° C., about 30° C. to about 60° C., about 50° C. to about 180° C., about 70° C. to about 180° C., about 90° C. to about 180° C., about 110° C. to about 180° C., about 130° C. to about 180° C., about 150° C. to about 180° C., about 30° C. to about 150° C., about 30° C. to about 130° C., about 50 CC to about 110° C., or about 80° C. to about 90° C.

In step 304, spacer material may be any material described above, such as a thermoplastic material. The spacer material may be applied by any method described above, such as by extrusion. The spacer material may be applied in any location described above, such as generally along but set in from the perimeter of the first lite. The first lite may be at ambient temperature. The spacer material may be at any temperature described above, such as at about 110° C. to about 140° C.

In step 306, the first lite and second lite are pressed together, such as by a platen press. A spacer material may have been applied to the first lite, as in step 304. The second lite may have been heated, as in step 302.

In optional step 308, the sealant material may be any material described above, such as silicone. The sealant material may be applied in any location described above, such as external to the spacer material, between the spacer material and the perimeter of the pressed lites.

In some implementations, either or both of the first lite and second lite is an assembly, such as a laminate or an insulating glass unit, which may be a double insulating glass unit. In one example, a double insulating glass unit may be introduced to the method 300 as a first lite. The double insulating glass unit may have been produced by the method 300 or any other method for producing insulating glass units. In step 304, a spacer material is applied to the first lite (double insulating glass unit). In step 306, the first lite (double insulating glass unit) is pressed together with a second lite. A triple insulating glass unit may be produced.

FIG. 3B illustrates a method 310 of preparing an insulating glass unit according to an embodiment. Method 310 includes a step 304 of applying a spacer material to a first lite; a step 316 of pressing together the first lite and a second lite; and a step 312 of heating the second lite. In some embodiments, the method 310 includes a step 318 of applying a sealant material.

The steps 314, 316, 312, and 318 (optionally) of the method 310 may be performed sequentially in any order, contemporaneously, separately, together, or any combination thereof. For example, and as indicated by dashed arrows in FIG. 3B, step 312 and step 318 may be performed sequentially with either step 312, 318 being performed first or the steps 312, 318 may, be performed contemporaneously. In some embodiments, the method 300 includes a step (not shown) of washing one or more lites.

In some implementations, the method 310 is performed on an assembly line, such as a line for producing insulating glass units. In some implementations, one or more of steps 312, 314, 316, and 318 are performed discretely or not as part of a progressive assembly.

Method 310 is similar to method 300 except for the order in which steps may be performed. Steps 312; 314, 316, and 318 are as described above for step 302, 304; 306, and 308; respectively.

As described for method 300; in method 310, either or both of the first lite and second lite may be an assembly, such as a laminate or an insulating glass unit, which may be a double insulating glass unit.

FIG. 3C illustrates a method 320 of preparing an insulating glass unit according to an embodiment. Method 320 includes a step 324 of applying a spacer material to a first lite; a step 326 of pressing together the first lite and a second lite; and a step 329 of heating the pressed first and second lites. In some embodiments, the method 320 includes a step 328 of applying a sealant material.

The steps 324, 326, 329, and 328 (optionally) of the method 320 may be performed sequentially in any order, contemporaneously, separately, together, or any combination thereof. In some embodiments, the method 310 includes a step (not shown) of washing one or more lites.

In some implementations, the method 320 is performed on an assembly line, such as a line for producing insulating glass units. In some implementations, one or more of steps 324, 326, 328, and 329 are performed discretely or not as part of a progressive assembly.

Method 320 is similar to method 300 except it includes a step 329 of heating the pressed lites after a step 326 of pressing together the first lite and second lite, such as to form a unit. In step 329, the pressed unit (first and second lites) is heated by any mechanism described above and to any temperature described above.

Steps 324, 326, and optional step 328 are as described above for step 304, 306, and 308, respectively. Step 329 is similar to step 302 except the first and second lites have been pressed together and the entire pressed unit is heated. The method 320 may also include a step of heating the second lite (not shown) similar to step 302 described above.

As described above for method 300, in method 320, either or both of the first lite and second lite may be an assembly, such as a laminate or an insulating glass unit, which may be a double insulating glass unit.

FIG. 3D illustrates a method 350 of preparing an insulating glass unit according to an embodiment. Method 350 includes a step 354 of applying a spacer material to a first lite; a step 355 of heating the first lite; and a step 356 of pressing together the first lite and a second lite. In some embodiments, the method 350 includes a step 352 of heating the second lite. In some embodiments, the method 350 includes a step 358 of applying a sealant material.

The steps 354, 355, and 356 and optional steps 352 and 358 of the method 350 may be performed sequentially in any order, contemporaneously, separately, together, or any combination thereof. For example, step 355 may be performed before step 354. Each of step 354 and 355 may be performed before step 356. In some embodiments, step 355 and step 356 occur contemporaneously. In some embodiments, step 355 occurs after step 356 but before step 358, if step 358 is included in the method 350. Optional step 352 may be performed before, after, or contemporaneously with any of step 354, step 355, or step 356. In some embodiments, the method 350 includes a step (not shown) of washing one or more lites and step 355, and optional step 352, occur after the washing step.

In some implementations, the method 350 is performed on an assembly line, such as a line for producing insulating glass units. In some implementations, one or more of steps 352, 354, 355, 356, and 358 are performed discretely or not as part of a progressive assembly.

Method 350 is similar to method 300 except it includes a step 355 of heating the first lite after a step 354 of applying the spacer to the first lite. In step 355, the first lite is heated by any mechanism described above and to any temperature described above.

Step 354 and optional steps 352 and 358 are as described above for step 304, 302, and 308, respectively. Step 356 is similar to step 306 except the heated first lite to which spacer material has been applied is pressed together with the second lite.

The method 350 may not include a step 352 of heating the second lite, or the method 350 may include a step 352 of heating the second lite similar to step 302 described above.

As described for method 300, in method 350, either or both of the first lite and second lite may be an assembly, such as a laminate or an insulating glass unit, which may be a double insulating glass unit.

In the implementations and use of a method 300, 310, 320, 350 of preparing an insulating glass unit, including at least one heating step 302, 312, 329, 352, 355 may help achieve faster wet-out of the second lite than methods that do not include at least one heating step 302, 312, 329, 352, 355.

Complete (100%) second lite wet-out, as determined by the method described in Example 1 below, may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 90% to about 100% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 80% to about 90% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

About 70% to about 80% second lite wet-out may occur in less than about 16 hours after pressing together two lites, less than about 12 hours, less than about 8 hours, less than about 4 hours, less than about 1 hour, less than about 30 minutes, less than about 15 minutes, less than about 10 minutes, less than about 5 minutes, less than about 1 minute, about 1 second to about 90 seconds, about 1 second to about 75 seconds, about 1 second to about 60 seconds, about 1 second to about 45 seconds, about 1 second to about 15 seconds, about 15 seconds to about 90 seconds, about 30 seconds to about 90 seconds, about 45 seconds to about 90 seconds, about 60 seconds to about 90 seconds, or about 75 seconds to about 90 seconds after pressing.

In the implementations and use of a method 300, 350 of preparing an insulating glass unit, rapid and extensive wet-out of the second lite permits accurate inspection of insulating glass units soon or immediately after assembly. Real-time adjustment of step parameters, such as of steps 302, 304, 306, 354, 355, and/or 356 is possible if, for example, poor wet-out is observed. Compared to slow second lite wet-out of known methods for producing an insulating glass unit, the presently disclosed rapid and extensive wet-out of the second lite may help decrease or eliminate the need for insulating glass unit storage space prior to shipping, decrease or eliminate insulating glass unit storage time prior to shipping, decrease the time between assembly and laying an insulating glass unit in a horizontal position, decrease the time between assembly and packing of an insulating glass unit, and/or decrease the time between assembly and shipping of an insulating glass unitinsulating.

### EXAMPLES

### Example 1 Match Lite Wet-Out

Insulating glass unit (IGU) samples (14 inches×20 inches) were assembled by, extruding a thermoplastic spacer material on an applied lite on an insulating glass production line (LiSEC America, Inc., Burnsville, Minn.). Immediate and complete wet-out of the spacer material on the applied lite was observed. A match lite was heated in an oven external to the line and was introduced to the line immediately before the press. The temperature (° C.+/−<5° C.) of the match lite was measured using an infrared pyrometer before the lite entered the press (“Temp. Before Press,” Table 1). An unheated match lite sample (“18 (Ambient),” Table 1) served as a control.

A heated or control match lite was pressed together with a spacer-coated applied lite in the press. The pressed lite units proceeded along the production line and then the unit perimeters, between the spacer material and the lite edges, were filled with silicone to produce an IGU. After being filled but before exiting the line (i.e., approximately 60 seconds after pressing), match lite wet-out was determined by measuring the number of linear inches along the match lite perimeter that demonstrated wet-out (i.e., that visually appeared black or dark as opposed to the gray or hazy, appearance of unwetted liter) and is reported as a percentage of the total perimeter (68 inches) (“Initial Wet-out,” Table 1). Wet-out of the match lite was also evaluated 3 hours and 16 hours later. Results are presented in Table 1. “ND” means no data was collected.

TABLE 1

| Temp. | | | |
|---|---|---|---|
| Before | Initial Wet- | 3-hr Wet- | 16-hr Wet- |
| Press (° C.) | out (%) | out (%) | out (%) |
| 110 | 100 | 100 | 100 |
| | 100 | 100 | 100 |
| | 100 | 100 | 100 |
| 90 | 100 | 100 | 100 |
| | 100 | 100 | 100 |
| | 100 | 100 | 100 |
| 70 | 85 | 100 | 100 |
| | 75 | ND | 100 |
| | 90 | ND | 100 |
| 50 | 10-15 | 95 | 95 |
| | 20-25 | ND | 100 |
| | 15-20 | ND | 99 |
| 30 | 0 | 75 | 100 |
| | 0 | ND | 95 |
| | 0 | ND | 100 |
| 18 | 0 | 0 | 40 |
| (Ambient) | 0 | 0 | 50 |
| | 0 | 0 | 30 |

Control IGU samples constructed with an ambient-temperature match lite achieved no wet-out until after more than 3 hours post-production. The control IGUs achieved no greater than 50% wet-out after 16 hours.

IGU samples constructed with match lites heated to 30° C. before entering the press demonstrated no immediate wet-out but wet-out was nearly complete at 16 hours post-production. IGU samples constructed with match lites heated to 50° C. before entering the press demonstrated some initial wet-out and wet-out was nearly complete between 3 hours and 16 hours post-production. IGU samples constructed with match lites heated to 70° C. before entering the press demonstrated a high amount of initial wet-out and wet-out was complete by 3 hours post-production. IGU samples constructed with match lites heated to 90° C. or 110° C. before entering the press demonstrated immediate wet-out.

The data demonstrate that, compared to unheated control IGU samples, heating the match lite to 30° C. or greater significantly decreased the time to both the onset and the completion of match lite wet-out. Complete or near-complete match lite wet-out was achieved at temperatures as low as 30° C. by 16 hours post-production. Complete or near-complete match lite wet-out was achieved at temperatures of 50° C. to 70° C. by 3 hours post-production. Immediate and complete match lite wet-out was achieved by heating the match lite to 90° C. to 110° C.

### Example 2—Butterfly Test

A butterfly sealant bonding test was performed on the samples prepared in Example according to industry standards. Briefly, 24 hours after production, the IGU samples were cut to produce three unsealed edges and to maintain one sealed (thermoplastic spacer plus silicone) edge. The spacer material had a width of about ¼ inch and a length of about 19 inches. The samples were placed flat on a horizontal surface. From the exposed edge opposite the sealed edge, one lite was lifted up and rotated about the sealed edge through 180° until the lite was again flat on the horizontal surface. In other words, the IGU was butterflied or laid open like a book.

IGU samples were then evaluated for the area of spacer that remained bonded to both lites rather than breaking away. Results are presented in Table 2.

TABLE 2

| Temp. Before | 24 hr Butterfly Test |
|---|---|
| Press (° C.) | (% cohesive failure) |
| 110 | 80 |
| | 90 |
| 90 | 100 |
| 70 | 100 |
| 50 | 99 |
| 30 | 90 |
| 18 (Ambient) | 5 |
| | 5 |

The data demonstrate that, compared to unheated control IGU samples, heating the match lite to 30° C. or greater significantly improved spacer adhesion by 24 hours post-production. Percent cohesive failure was similar for IGU samples prepared with a match lite heated to 30° C. to 110° C. prior to pressing.

Producing IGUs using a heated match lite significantly increases the reliability of the spacer adhesion compared to known methods. Producing IGUs using a heated match lite significantly decreases the time to generate strong spacer adhesion compared to known methods.

Although various representative embodiments have been described above with a certain degree of particularity, those skilled in the art could make numerous alterations to the disclosed embodiments without departing from the spirit or scope of the inventive subject matter set forth in the specification and claims. Joinder references (e.g., attached, coupled, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure. It is intended that all matter contained in the above description or shown in the accompanying drawings shall be interpreted as illustrative only and not limiting. Changes in detail or structure may be made without departing from the spirit of the disclosure as defined in the appended claims.

Although the present disclosure has been described with reference to preferred embodiments, persons skilled in the art will recognize that changes may be made in form and detail without departing from the spirit and scope of the disclosure.

What is claimed is:

1. A method for producing an insulating glass unit, the method comprising:
applying a spacer material to a first lite;
heating a second lite; and
pressing together the first lite and the second lite to form an insulating glass unit.

2. The method of claim 1, wherein at least 90% wet-out of the second lite by the spacer material occurs in less than 60 seconds after pressing together the first lite and the second lite.

3. The method of claim 1, wherein 100% wet-out of the second lite by the spacer material occurs in less than 60 seconds after pressing together the first lite and the second lite.

4. The method of claim 1, wherein the second lite is heated by a radiation, convection, or conduction heat source.

5. The method of claim 4, wherein the radiation heat source is infrared, shortwave, or medium wave radiation.

6. The method of claim 1, wherein the second lite is heated prior to pressing together the first lite and the second lite.

7. The method of claim 1, wherein the second lite is heated to about 30° C. to about 180° C.

8. The method of claim 1, wherein the second lite is heated to about 30° C. to about 130° C.

9. The method of claim 1, further comprising applying a sealant material external to the spacer material.

10. The method of any one of claim 1, further comprising heating the first lite.

11. A method for producing an insulating glass unit, the method comprising:
applying a spacer material to a first lite;
heating the first lite having a spacer material applied thereon; and
pressing together the first lite and a second lite to form an insulating glass unit.

12. The method of claim 11, wherein at least 90% wet-out of the second lite by the spacer material occurs in less than 60 seconds after pressing together the first lite and the second lite.

13. The method of claim 11, wherein at least 95% wet-out of the second lite by the spacer material occurs in less than 60 seconds after pressing together the first lite and the second lite.

14. The method of claim 11, wherein the heating is by radiation, convection, or conduction.

15. The method of claim 14, wherein the heating in by infrared, shortwave, or medium wave radiation.

16. The method of claim 11, wherein the first lite is heated to about 30° C. to about 180° C.

17. The method of claim 11, wherein the second lite is heated to about 30° C. to about 130° C.

18. The method of claim 11, further comprising applying a sealant material external to the spacer material.

19. The method of claim 11, further comprising heating the second lite.

20. A system for producing an insulating glass unit, the system comprising:
a thermoplastic material applicator configured to apply a spacer material to a first lite;
a heating mechanism configured to heat at least one of the first lite and a second lite; and
a press configured to press together the first lite and the second lite.

21. The system of claim 20, wherein the heating mechanism is a radiation, convection, or conduction heater.

22. The system of claim 20, wherein the heating mechanism heats at least one of the first lite or the second lite such that at least 90% wet-out of the second lite by the spacer material occurs in less than 60 seconds after pressing together the first lite and the second lite.

23. The system of claim 20, wherein the heating mechanism heats at least one of the first lite or the second lite such that at least 95% wet-out of the second lite by the spacer material occurs in less than 60 seconds after pressing together the first lite and the second lite

24. The system of claim 20, wherein the heating mechanism operates prior to the press.

25. The system of claim 20, further comprising a sealant applicator configured to apply a sealant material external to the spacer material.
